(19) United States
(12) Patent Application Publication
(10) Pub. No.: US 2016/0007276 A1
(43) Pub. Date: Jan. 7, 2016

(54) Wi-Fi Support Awareness

(71) Applicant: NOKIA SOLUTIONS AND NETWORKS OY, Espoo (FI)

(72) Inventor: Mika Forssell, Tolkkinen (FI)

(73) Assignee: Nokia Solutions and Networks Oy, Espoo (FI)

(21) Appl. No.: 14/776,053

(22) PCT Filed: Mar. 14, 2013
(86) PCT No.: PCT/EP2013/055248

§ 371 Date: Sep. 14, 2015

(51) Int. Cl. H04W 48/16; H04W 8/24

(52) U.S. Cl. CPC H04W 48/16; H04W 8/24; H04W 88/06

(57) ABSTRACT

There are provided measures for Wi-Fi support awareness. Such measures exemplarily include dynamically determining capability for a radio access technology while being connected to a communication network, and transmitting, via the connection to the communication network, a message comprising an information element indicative of the capability for the radio access technology.

### FIELD

The present invention relates to Wi-Fi support awareness. More specifically, the present invention exemplarily relates to measures (including methods, apparatuses and computer program products) for realizing Wi-Fi support awareness.

### BACKGROUND

Wi-Fi networks are becoming integral part of mobile broadband. Wi-Fi is already a standard feature on smart phones, tablets and laptops. Major operators are either already using Wi-Fi or planning to deploy Wi-Fi solutions. According to market reports, Wi-Fi usage increases all the time.

### SUMMARY

Various exemplary embodiments of the present invention aim at addressing at least part of issues and/or problems and drawbacks mentioned in detail below.

Various aspects of exemplary embodiments of the present invention are set out in the appended claims.

According to an exemplary aspect of the present invention, there is provided a method comprising dynamically determining capability for a radio access technology while being connected to a communication network, and transmitting, via said connection to said communication network, a message comprising an information element indicative of said capability for said radio access technology.

According to an exemplary aspect of the present invention, there is provided a method comprising receiving a message comprising an information element indicative of capability for a radio access technology associated with a user equipment (UE), and considering a sender of said message for interworking of a radio access network with said radio access technology in terms of said user equipment based on said capability.

According to an exemplary aspect of the present invention, there is provided a method comprising obtaining capability for a radio access technology and/or a service associated with a user equipment (UE), and dynamically modifying a predetermined position in an index based on said capability, wherein said index indicates settings for radio resources at said user equipment.

According to an exemplary aspect of the present invention, there is provided a method comprising receiving an index, and considering a user equipment (UE) for interworking of a radio access network with said radio access technology based on a value on a predetermined position in said index indicative of a capability for said radio access technology and/or a service associated with said user equipment, wherein said index indicates settings for radio resources at the user equipment.

According to an exemplary aspect of the present invention, there is provided an apparatus comprising determining means configured to dynamically determine capability for a radio access technology while being connected to a communication network, and transmitting means configured to transmit, via said connection to said communication network, a message comprising an information element indicative of said capability for said radio access technology.

According to an exemplary aspect of the present invention, there is provided an apparatus comprising receiving means configured to receive a message comprising an information element indicative of capability for a radio access technology associated with a user equipment (UE), and considering means configured to consider a sender of said message for interworking of a radio access network with said radio access technology in terms of said user equipment based on said capability.

According to an exemplary aspect of the present invention, there is provided an apparatus comprising obtaining means configured to obtain capability for a radio access technology and/or a service associated with a user equipment (UE), and modifying means configured to dynamically modify a predetermined position in an index based on said capability, wherein said index indicates settings for radio resources at said user equipment.

According to an exemplary aspect of the present invention, there is provided an apparatus comprising receiving means configured to receive an index, and considering means configured to consider a user equipment (UE) for interworking of a radio access network with said radio access technology based on a value on a predetermined position in said index indicative of a capability for said radio access technology and/or a service associated with said user equipment, wherein said index indicates settings for radio resources at the user equipment.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient Wi-Fi support awareness. Namely, as there are legacy and new UEs in the network with different capabilities, network needs to know if a given UE supports 1) Wi-Fi access, 2) RAN/Wi-Fi Interworking and 3) if user has Wi-Fi service subscription in order to be able to utilize Wi-Fi networks. Anyone of the above aspects enables to solve at least part of the problems and drawbacks identified in relation to the prior art.

By way of exemplary embodiments of the present invention, there is provided Wi-Fi support awareness. More specifically, by way of exemplary embodiments of the present invention, there are provided measures and mechanisms for realizing Wi-Fi support awareness.

Thus, improvement is achieved by methods, apparatuses and computer program products enabling/realizing Wi-Fi support awareness.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a block diagram illustrating an apparatus according to exemplary embodiments of the present invention,

FIG. 3 is a block diagram illustrating an apparatus according to exemplary embodiments of the present invention,

FIG. 4 is a block diagram illustrating an apparatus according to exemplary embodiments of the present invention,

FIG. 5 is a schematic diagram of a procedure according to exemplary embodiments of the present invention,

FIG. 6 is a schematic diagram of a procedure according to exemplary embodiments of the present invention,

FIG. 7 is a schematic diagram of a procedure according to exemplary embodiments of the present invention,

FIG. 8 is a schematic diagram of a procedure according to exemplary embodiments of the present invention,

FIG. 9 is a schematic diagram illustrating exemplary RFSP RAT configuration,

FIG. 10 shows a schematic diagram of signaling sequences according to exemplary embodiments of the present invention,

FIGS. 11 and 12 are block diagrams alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, deployments implementing Wi-Fi scenarios are used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As Wi-Fi becomes just another cell aside mobile radio access networks, operators require more control and dynamic mechanisms how user device moves between mobile and Wi-Fi networks. Already required use cases include for example load balancing between mobile and Wi-Fi, and 3^{rd} Generation (3G)/Long Term Evolution (LTE) cell congestion based offload to Wi-Fi.

To improve tools provided for mobile operators to control how user equipments (UE) use mobile and Wi-Fi networks, 3^{rd} Generation Partnership Project (3GPP) Release 12 has started Radio Access Network (RAN)/Wi-Fi Interworking Study Item.

3GPP technical specification (TS) 25.306 defines a UE radio access capability information element. This is an existing mechanism for providing UE 3GPP (mainly radio related) characteristics to the network. Based on the information the network for example learns which 3GPP features are supported by the UE. Currently, UE radio access capability information element includes static information.

In 3GPP release 12, RAN/Wi-Fi Interworking Study Item has started to develop technologies enabling dynamic control how UE uses mobile and Wi-Fi networks. The work has just started and thus detailed technologies and solutions don't exist yet.

A radio frequency selection priority (RFSP) based mechanism is considered as one option to enable dynamic traffic steering between mobile and Wi-Fi networks as part of 3GPP release 12 RAN/Wi-Fi Interworking topic. It is not described how the network knows to which UEs Wi-Fi radio access technology (RAT) priorities can be applied.

Hence, the problem arises that the network does not know to which UEs Wi-Fi network selection mechanisms can be applied. For example if assigning Wi-Fi selection rules to UE not supporting Wi-Fi may confuse the UE and lead into an error situation. Or if assigning Wi-Fi selection rules to UE supporting Wi-Fi access but where the user doesn't have Wi-Fi service subscription, authentication, authorization and accounting (AAA) server blocks Wi-Fi access leading to bad user experience.

A possible mechanism may be to include “User Wi-Fi service subscription” field/information into affected messages and interfaces between different network elements (like Insert Subscriber Data from home subscriber server (HSS) to mobility management entity (MME) and Context Setup/Modification messages between MME and eNB (evolved Node B)).

However, this may require changing multiple interfaces.

Hence, there is a need to provide for Wi-Fi support awareness. In particular, there is a need for bringing UE and user Wi-Fi support awareness to the mobile network (without rendering necessary changing multiple interfaces).

According to exemplary embodiments of the present invention, in general terms, there are provided measures and mechanisms for (enabling/realizing) Wi-Fi support awareness.

Mobile network needs to know UE support for Wi-Fi access/RAN/Wi-Fi Interworking mechanism and user Wi-Fi service subscription status (Wi-Fi service enabled/disabled) in order to be able to consider Wi-Fi as one RAT and next destination network as part of a mechanism where RAN/mobile network has control over the usage of UE of mobile and Wi-Fi networks, i.e. over when a UE uses mobile and Wi-Fi networks (which might be a part of 3GPP release 12 RAN/Wi-Fi Interworking). According to exemplary embodiments of the present invention, alternatives are proposed how to make this awareness available to required network elements without requiring heavy standardization and changing multiple interfaces and messages. Also according to exemplary embodiments of the present invention, a new mechanism is described how to enable dynamic reporting of UE capabilities within UE radio access capability information element that contains today only fixed or static elements in 3GPP specifications.

In various exemplary embodiments of the invention, while being connected with 3GPP RAN, a UE is operable to dynamically determine Wi-Fi availability. For example, the UE may identify or determine Wi-Fi availability by dynamically checking the content of selection function (ANDSF) management object (MO) received from 3GPP network. In this regard, the 3GPP network may provide the UE with a radio access technology ID (RAT ID) assigned for Wi-Fi network. The UE may use the Wi-Fi RAT ID to acquire required information in case finding or discovering the Wi-Fi network. According to exemplary embodiments of the invention, the UE is operable or configured to concurrently report dynamic Wi-Fi capability to the 3GPP network while being connected with the 3GPP network. For example, without affecting ongoing connections with the 3GPP RAN, the UE may selectively report dynamic Wi-Fi capability for RAT/Frequency Selection Priority (RFSP) mechanism only in case where the UE at given time is able to access WLAN radio and Wi-Fi service.

According to exemplary embodiments of the invention, the 3GPP network may prioritize various RANs available at the specific UE in accordance with the corresponding RAN capability dynamically reported from the UE. For example, the 3GPP network may treat or consider Wi-Fi as “just another cell” aside the 3GPP RAN and may determine RAT priorities for 3GPP RAN as well as Wi-Fi network based on the Wi-Fi capability dynamically reported from the UE. In this regard, the UE may be managed by the 3GPP network to dynamically utilize and select the 3GPP RAN and/or the Wi-Fi network for services of interest.

According to exemplary embodiments of the invention, dynamic Wi-Fi capability reporting from the UE may be driven by the UE or by the 3GPP network. With a UE driven solution, the UE may comprise suitable logic, circuitry, interfaces, and/or code that may be operable to report and/or avoid reporting support for RAN/Wi-Fi Interworking without changing content of one or more existing information elements utilized in 3GPP specifications. In this regard, the UE driven solution may cause no changes or merely minimal changes to interfaces between network elements.

With a network driven solution, the 3GPP network may embed UE's dynamic Wi-Fi capability information such as user Wi-Fi service subscription status into network parameters such as the RFSP index to drive the selection and/or usage of the 3GPP RAN and/or the Wi-Fi network at the UE for services of interest.

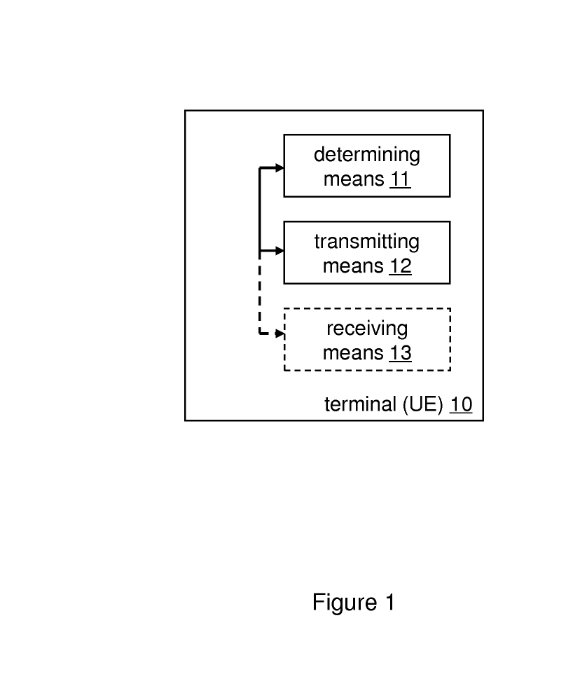

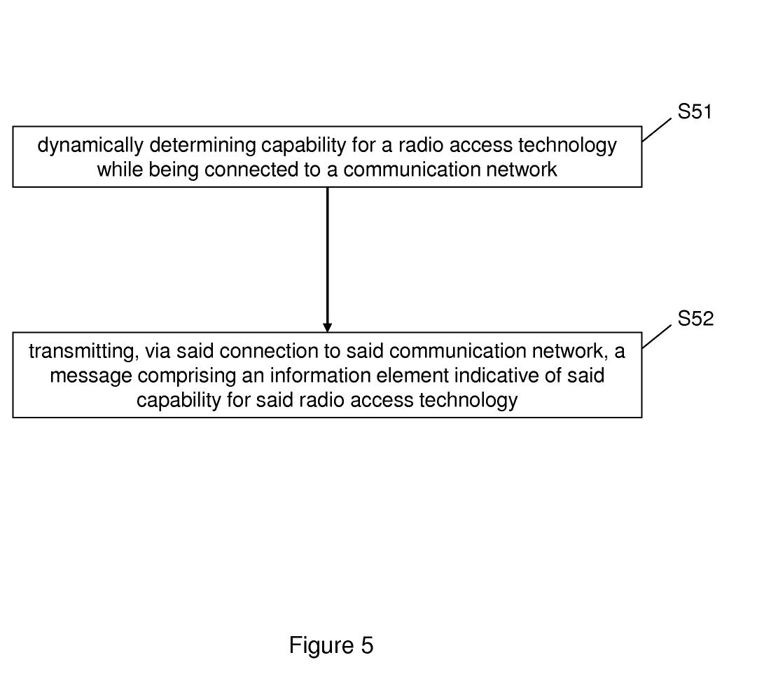

FIG. 1 is a block diagram illustrating an apparatus according to exemplary embodiments of the present invention. The apparatus may be a terminal such as a user equipment. FIG. 5 is a schematic diagram of a procedure according to exemplary embodiments of the present invention. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 1, according to exemplary embodiments of the present invention, the apparatus comprises a determining means 11 and a transmitting means 12. As shown in FIG. 5, a procedure according to exemplary embodiments of the present invention comprises an operation of dynamically determining capability for a radio access technology while being connected to a communication network, and an operation of transmitting, via said connection to said communication network, a message comprising an information element indicative of said capability for said radio access technology.

According to exemplary embodiments of the present invention, the capability for a radio access technology comprises at least one of support for said radio access technology, availability of service subscription for said radio access technology, and support for a network side mechanism in relation to said radio access technology. According to exemplary embodiments, the network side mechanism may be interworking of a radio access network with said radio access technology.

According to a variation of the procedure shown in FIG. 5, exemplary additional operations are given, which are inherently independent from each other as such. According to such variation, an exemplary method according to exemplary embodiments of the present invention may comprise an operation of listening for networks utilizing said radio access technology, and an operation of checking whether known and accessible networks utilizing said radio access technology are listened. In such case, the capability may comprise—alone or among others—that known and accessible networks utilizing said radio access technology are listened.

In other words, the UE may selectively report support for Wi-Fi to the network also only in case of being able to detect Wi-Fi networks (which it recognizes as familiar and being able to access to). This might be used (by the UE) for example when providing measurement reports to the network or for example RRCConnectionEstablishment message or the like to provide (online) information, if the UE supports Wi-Fi RAT and if known Wi-Fi is available to UE.

According to further exemplary embodiments of the present invention, the radio access technology is Wi-Fi. According to another embodiment of the present invention, the radio access technology is 3GPP radio access technology, like LTE 3.5 small cell. For example, an operator may dedicate certain 3GPP frequency band for gold, premium or VIP users to ensure better service quality. In the similar way as for Wi-Fi, the user may need to have separate service subscription to such a frequency band/network layer. Thus the special 3GPP frequency band, like 3.5 GHz small cell band being currently defined for 3GPP networks, could serve as the radio access technology, although in the preceding description the Wi-Fi is used as an example. In such case, the UE indicates support for the 3.5 frequency band in case the UE supports that technology and the user/UE has subscription to the service (user/UE is allowed to use that RAT). In general, the radio access technology is thus not to be understood to be limited to Wi-Fi or the 3GPP 3.5 GHz small cell band, but instead those technologies are to be considered merely as examples for various radio access technologies or frequency bands to be used for traffic besides the main mobile network.

It is further noted that according to exemplary embodiments of the present invention, in addition to the generic right (i.e. user based permission) to access e.g. 3.5 band (or other technologies/bands), zones might be defined. That is, UE indicates 3.5 band support only in selected areas defined by the operator, like when the user is at home the operator has defined that the user is able to access certain RAT (like 3.5) available in home area (like providing indoor coverage in a skyscraper), but otherwise the user is not allowed to access and benefit from the RAT (and get high speed connections via 3.5 small cell base station). In other words, according to exemplary embodiments of the present invention, the availability of service subscription may be a local permission.

According to still further embodiments of the present invention, the availability of service subscription may be a temporal permission, that is, for example a user/UE belongs to a group that is allowed to utilize small cells only during busy hour but otherwise shall use macro RATs.

The location and time based limitations may apply to both 3GPP and Wi-Fi RATs.

According to a variation of the procedure shown in FIG. 5, exemplary details of the determining operation are given, which are inherently independent from each other as such.

Such exemplary determining operation according to exemplary embodiments of the present invention may comprise at least one of an operation of receiving access network discovery and selection function information as information regarding service subscription for said radio access technology, an operation of receiving hotspot 2.0 information as information regarding service subscription for said radio access technology, and an operation of obtaining settings related to said radio access technology as information regarding service subscription for said radio access technology. The settings may be obtained from e.g. access data received over the air or configured by the user. The settings may alternatively be obtained from e.g. settings configured into the UE or a (universal) subscriber identity module ((U)SIM) card. That is, for example, a USIM contains some information if Wi-Fi service is enabled or disabled, which may be preconfigured by the operator.

In other words, UE indicates to network UE support for the mechanism in question (e.g. Wi-Fi, the 3GPP release 12 enhanced RFSP, or in general for RAN/Wi-Fi Interworking mechanism) only in case UE determines it has all the required characteristics available.

These characteristics include, that UE supports Wi-Fi access/radio, and that UE has received information (over the air from the network or via manual user or operator configuration) that user has Wi-Fi service subscription enabled, which grants access to Wi-Fi service.

The received information may be Access Network Discovery and Selection Function (ANDSF) information (see e.g. 3GPP TS 23.402), where ANDSF server provides 3GPP/Wi-Fi network selection policies to the UE, or Hotspot 2.0 information indicating access to operator services (for example Access Network Query Protocol (ANQP) indicating support for operators/services, like operator.com). The received information may further be derivable from that Device Management (DM) server has configured Wi-Fi related settings into the UE, for example service set identifier (SSID) defining approved Wi-Fi networks/hotspots and optionally authentication credentials for using the networks (e.g. defining UE shall use EAP-SIM, EAP-AKA or PEAP as authentication method), or that the user has configured other Wi-Fi networks than home (or optionally enterprise) Wi-Fi networks into the UE. For example home Wi-Fi uses typically WPA2-PSK authentication and security whereas hotspot uses 802.1x, WPA2-Enterprise, Captive Portal or EAP-SIM/EAP-AKA which the UE can use to determine whether it has Wi-Fi service subscription to a hotspot. The information may further be derivable from the (U)SIM card configured over the air or pre-configured (e.g. before assigning the card to the user) by the operator.

The characteristics may optionally further include that the UE has learned that the network supports 3GPP release 12 (or onwards) and RAN/Wi-Fi Interworking mechanism enabling RAN controlled traffic steering between mobile and Wi-Fi networks and indicates support for RAN/Wi-Fi Interworking only in such a case. Hence, the apparatus according to FIG. 1 may, as an optional component, comprise a receiving means 13 that enables the apparatus to detect whether certain features and/or 3GPP release are supported by the network in order to report Wi-Fi (or e.g. 3GPP 3.5 GHz small cell band or other technologies/bands) capability to the network. For example, if RAN doesn't support the exemplary 3GPP Rel12 RAN/Wi-Fi Interworking feature, the Wi-Fi capability is not reported to the network.

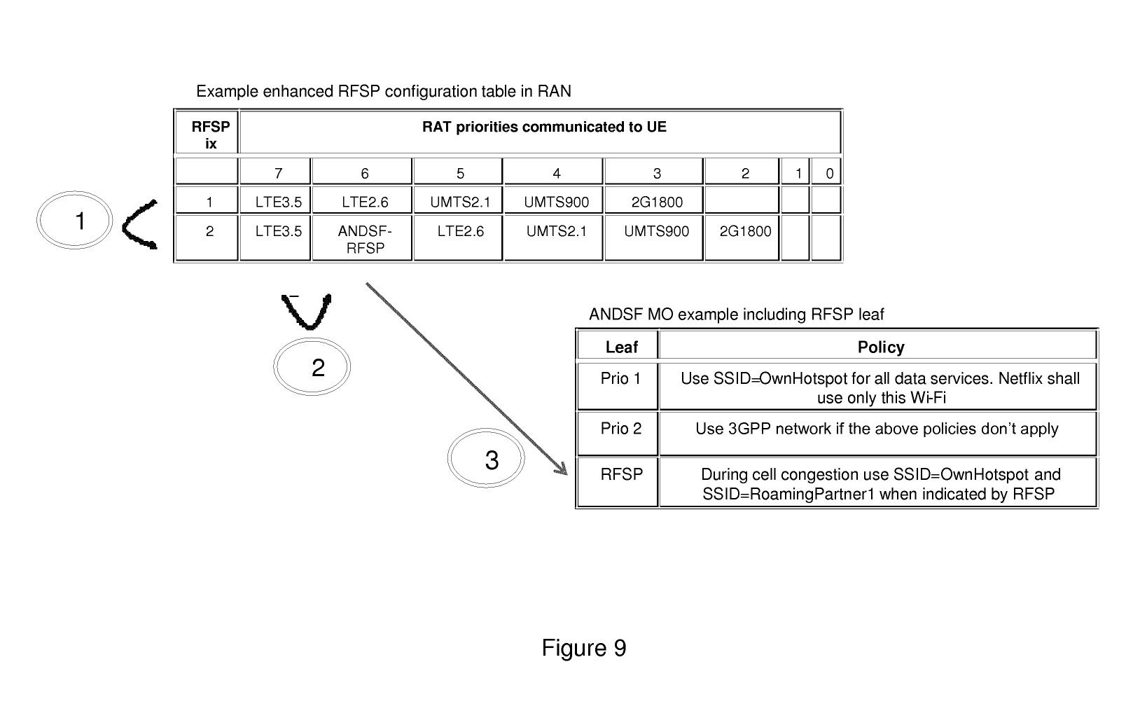

The enhanced RFSP mechanism as mentioned above assumes that ANDSF server has provisioned beforehand ANDSF RFSP information to a UE allowing the enhanced RFSP mechanism then refer to the ANDSF RFSP information via Wi-Fi RAT priorities. Exemplary ANDSF RFSP information can be seen on the schematic diagram of FIG. 9, illustrating an exemplary RFSP RAT configuration. Also Hotspot 2.0 ANQP network selection or alike mechanism and information may be used instead or in addition to ANDSF. In this regard it is noted that Hotspot 2.0 release 2 will contain e.g. ANQP mechanism where the operator may configure over the air network selection policies to the UE, which is considerable as similar to ANDSF as described above.

In case the UE supports Wi-Fi access and the UE has received required information for accessing Wi-Fi service and/or utilizing RAN/Wi-Fi Interworking mechanisms (like ANDSF information), then the UE indicates support for Wi-Fi access (or RAN/Wi-Fi Interworking mechanism) for example within “UE radio access capability” information element (see 3GPP TS 25.306). In the “UE radio access capability” information element there is for example a Multi-RAT container where a new field “Support for Wi-Fi” or “Support for RAN/Wi-Fi Interworking” can be added. This information element enables eNB, RNC, MME and SGSN to know if Wi-Fi can be used with the UE or not as part of RAN/Wi-Fi Interworking mechanism (e.g. enhanced RFSP or alike) without further changes. As an alternative to the “UE radio access capability” information element, the support for Wi-Fi access may also be indicated as already mentioned above for example when providing measurement reports or an RRCConnectionEstablishment message to the network.

As an option, in addition to indicating support for Wi-Fi access/service, the UE may also add more detailed information to inform the network support for a service. For example the UE may list SSIDs, operators, Fully Qualified Domain Name (FQDN), Hotspot 2.0 roaming consortium etc. details enabling the network to know which Wi-Fi networks are usable for the user/UE. As an example, in a given area there may be operator own hotspots and also roaming part hotspots available and according to user Wi-Fi subscription the roaming partner hotspots may or may not be accessible for the user.

For example in case 3GPP release 12 standardizes enhanced RFSP mentioned above, the enhanced RFSP refers to ANDSF Management Object content as part of Wi-Fi RAT priority. Therefore, in case the UE hasn't received required ANDSF information the UE can't use the Wi-Fi RAT priority as part of the enhanced RFSP mechanism and thus does not indicate support for Wi-Fi access or RAN/Wi-Fi Interworking in “UE radio access capability”.

According to a variation of the procedure shown in FIG. 5, exemplary additional operations are given, which are inherently independent from each other as such. According to such variation, an exemplary method according to exemplary embodiments of the present invention may comprise an operation of requesting information regarding service subscription for said radio access technology.

In other words, as a recommended option, in case the UE hasn't received required RAN/Wi-Fi Interworking information from the network, for example ANDSF Management Object referred by RAN/Wi-Fi Interworking mechanism (enhanced RFSP), and the UE notices network supporting 3GPP release 12 RAN/Wi-Fi Interworking technology or the UE receives as part of RFSP mechanism Wi-Fi RAT priorities, the UE may trigger connection establishment towards the ANDSF server (or alike network element providing further details about Wi-Fi usage like Hotspot 2.0 ANQP server or RAN itself (e.g. over RRC signalling)) to retrieve the required information. As part of the connection establishment towards e.g. ANDSF server the UE may indicate specific need for RAN/Wi-Fi Interworking details/content (to get focused information), or just obtain the latest information provided by the server (where RFSP information is included if supported by the server for the user).

According to a variation of the procedure shown in FIG. 5, exemplary additional operations are given, which are inherently independent from each other as such. According to such variation, an exemplary method according to exemplary embodiments of the present invention may comprise an operation of adding said information element indicative of said capability for said radio access technology to said message.

In case the UE doesn't support Wi-Fi access/radio or the UE hasn't received required information for accessing Wi-Fi service and/or utilizing RAN/Wi-Fi Interworking mechanisms (even after attempting to get the information), then the UE shall not indicate support for RAN/Wi-Fi Interworking as part of “UE radio access capability”. This causes eNB, RNC, SGSN and MME to ignore Wi-Fi as part of traffic steering actions and causes these network elements to consider only 3GPP RATs (like 3G and LTE) as part of the traffic steering.

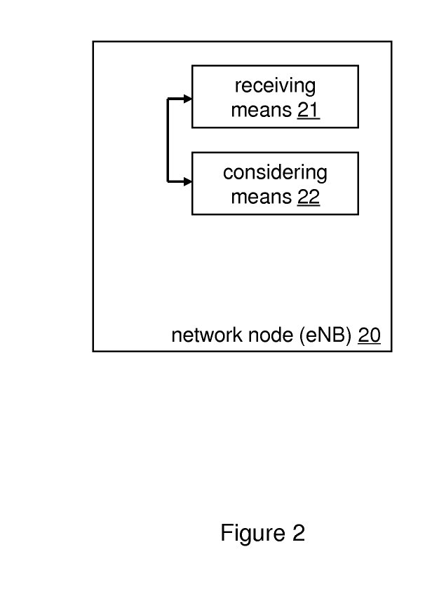

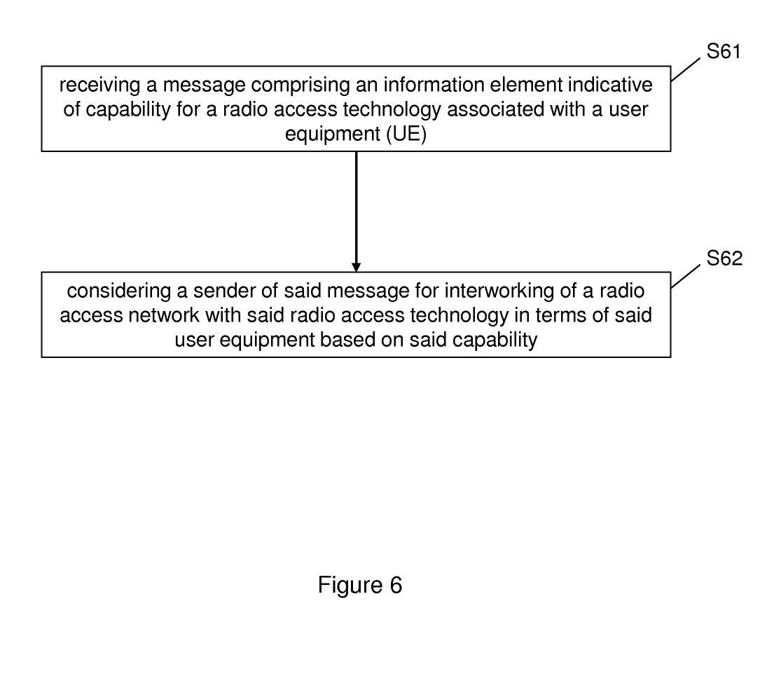

FIG. 2 is a block diagram illustrating an apparatus according to exemplary embodiments of the present invention. The apparatus may be a network node such as an evolved Node B (eNB). FIG. 6 is a schematic diagram of a procedure according to exemplary embodiments of the present invention. The apparatus according to FIG. 2 may perform the method of FIG. 6 but is not limited to this method. The method of FIG. 6 may be performed by the apparatus of FIG. 2 but is not limited to being performed by this apparatus.

As shown in FIG. 2, according to exemplary embodiments of the present invention, the apparatus comprises a receiving means 21 and a considering means 22. As shown in FIG. 6, a procedure according to exemplary embodiments of the present invention comprises an operation of receiving a message comprising an information element indicative of capability for a radio access technology associated with a user equipment (UE), and an operation of considering a sender of said message for interworking of a radio access network with said radio access technology in terms of said user equipment based on said capability.

According to exemplary embodiments of the present invention, said capability is at least one of support for said radio access technology, availability of service subscription for said radio access technology, and support for a network side mechanism in relation to said radio access technology (e.g. interworking of a radio access network with said radio access technology).

According to still further embodiments of the present invention, the radio access technology is Wi-Fi, or 3GPP radio access technology (or any other conceivable radio access technology or frequency band).

According to a variation of the procedure shown in FIG. 6, exemplary additional operations are given, which are inherently independent from each other as such.

According to such variation, an exemplary method according to exemplary embodiments of the present invention may comprise an operation of transmitting access network discovery and selection function information as information regarding service subscription for said radio access technology, and an operation of transmitting hotspot 2.0 information as information regarding service subscription for said radio access technology.

According to a variation of the procedure shown in FIG. 6, exemplary additional operations are given, which are inherently independent from each other as such. According to such variation, an exemplary method according to exemplary embodiments of the present invention may comprise an operation of receiving a request for information regarding service subscription for said radio access technology.

The information element received with the message enables for example eNB, RNC, MME and SGSN to know if Wi-Fi can be used with the UE or not as part of RAN/Wi-Fi Interworking mechanism (e.g. enhanced RFSP or alike) without further changes, i.e. if the respective UE is capable of Wi-Fi.

In case the UE is not capable of Wi-Fi, eNB, RNC, SGSN and MME are caused to ignore Wi-Fi as part of traffic steering actions and to consider only 3GPP RATs (like 3G and LTE) as part of the traffic steering.

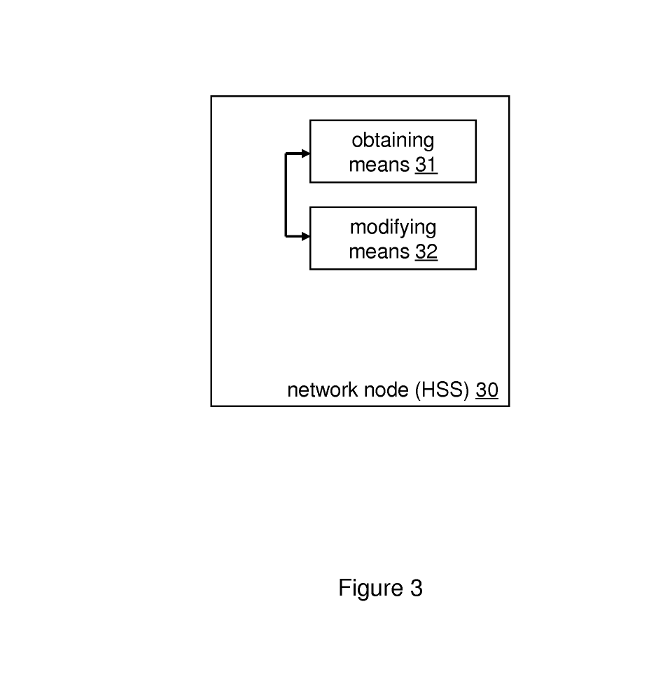

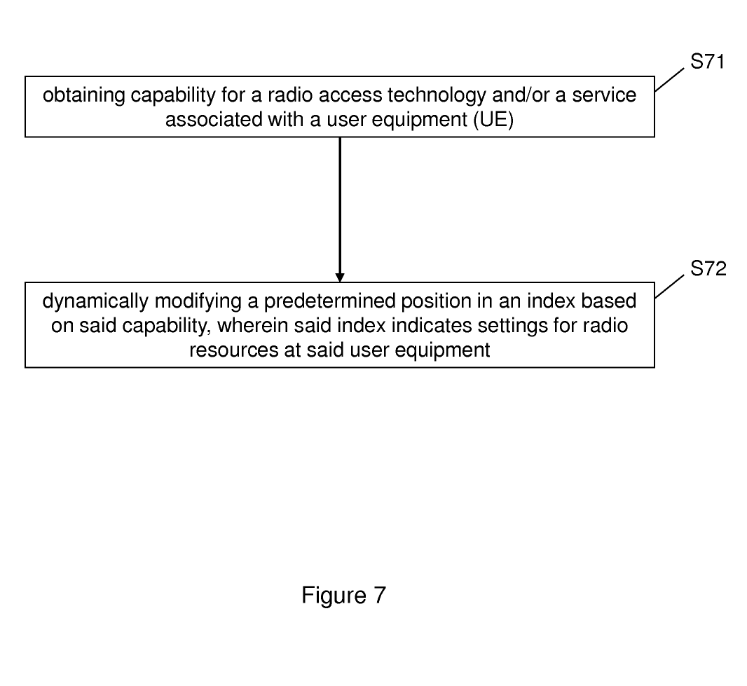

FIG. 3 is a block diagram illustrating an apparatus according to exemplary embodiments of the present invention. The apparatus may be a network node such as a home subscriber server. FIG. 7 is a schematic diagram of a procedure according to exemplary embodiments of the present invention. The apparatus according to FIG. 3 may perform the method of FIG. 7 but is not limited to this method. The method of FIG. 7 may be performed by the apparatus of FIG. 3 but is not limited to being performed by this apparatus.

As shown in FIG. 3, according to exemplary embodiments of the present invention, the apparatus comprises an obtaining means 31 and a modifying means 32. As shown in FIG. 7, a procedure according to exemplary embodiments of the present invention comprises an operation of obtaining capability for a radio access technology and/or a service associated with a user equipment (UE), and an operation of dynamically modifying a predetermined position in an index based on said capability, wherein said index indicates settings for radio resources at said user equipment.

With the network model/solution, RFSP index is embedded to carry information describing user Wi-Fi service subscription status. According to exemplary embodiments of the invention, the user Wi-Fi service subscription status may be dynamically acquired through the network for the corresponding UE. In this regard, in instances where Wi-Fi capability such as the user Wi-Fi service subscription status of the UE varies or changes while the UE is being connected to the 3GPP network, the 3GPP network may dynamically configure or modify content in RFSP index, for example, corresponding to the UE in response to such changes.

In case 3GPP release 12 standardizes enhanced RFSP as mentioned above, the following applies. In order to avoid standardization changes to multiple network interfaces and as RFSP index (taking values between 1 . . . 256) allocation is operator specific, operator specific RFSP index coding is used according to exemplary embodiments of the present invention to denote user eligibility for Wi-Fi service or 3GPP radio access technology (e.g. 3GPP 3.5 small cell, or any other conceivable radio access technology or frequency band). For example, an N-th bit within the RFSP index may (dynamically or statically) denote whether Wi-Fi service subscription is enabled for the user or not, still leaving multiple values for the RFSP index itself.

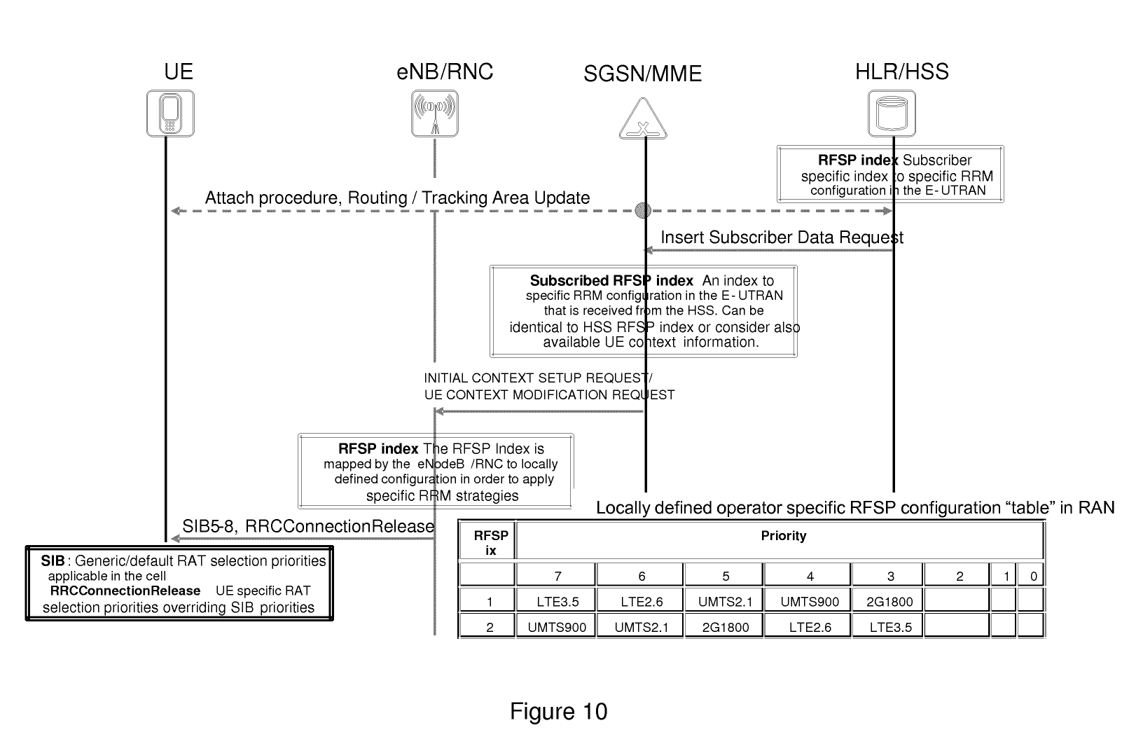

As an example “1 xxxx xxxxb” indicates user with Wi-Fi subscription and “0 xxxx xxxxb” indicates user without Wi-Fi subscription. Modifying the other bits (denoted by x in the example) provides room for HSS, MME, SGSN, eNB and RNC to change RFSP index allocated for the user and still provide Wi-Fi service subscription information to other elements. Then operator may dynamically set the RFSP index into HSS in accordance with the UE Wi-Fi (or other RAT) capability, HSS provides the RFSP index to MME/SGSN e.g. as part of UE making attachment, and MME/SGSN provides the RFSP index to eNB/RNC, as shown in FIG. 10, illustrating a schematic diagram of signaling sequences according to exemplary embodiments of the present invention.

According to still further embodiments of the present invention, the predetermined position is a bit position in said index, or the predetermined position is a bit range in said index.

That is, an RFSP index number range, like e.g. 130-140, may denote that Wi-Fi is supported by the user/UE.

As a further option according to exemplary embodiments of the present invention, a number range, bit in certain location within RFSP index etc. may dynamically indicate support for different services. For example number range 130-132 may denote support for operator own hotspots, number range 133-134 may denote support for roaming partner1 hotspots and number range 135-136 may denote support for roaming partner2 hotspots. Then eNB/RNC is able to consider which networks are available in a given area and which networks the user is allowed to access for example as part of the RFSP mechanism.

When using RFSP mechanism, home operator may dynamically configure user specific RFSP index into HSS as part of user profile. This RFSP index will then map to local RFSP RAT priority table within eNB/RNC. By configuring the RFSP index/user into HSS, the operator may influence that e.g. voice centric user use primarily 2G and 3G networks while premium heavy data users use primarily LTE and 3G.

The Home operator knows if the user has subscription to operator own Wi-Fi hotspot service and optionally to roaming partner Wi-Fi hotspot service (roaming agreements grant user access also to selected visited networks). Thus the operator may affect the configured RFSP index with this knowledge. For example when a user buys premium mobile data subscription, the operator grants access also to hotspot Wi-Fi service. If user buys low cost mobile data subscription, the user may have to buy separate Wi-Fi service subscription, and when the user does this it can be taken into account in RFSP index setting in HSS. RFSP index can be manually configured into HSS by the operator or there may be automation where when the user buys a subscription granting access to the Wi-Fi service the “charging and billing system” and/or “user subscription management system” automatically reconfigures user RFSP index in HSS.

It is noted that the position in the index is not fixed to the position exemplarily stated above. To the contrary, it can be placed anywhere in the index or any number range of RFSP index values may be used. In order to guarantee multi-vendor support for the mechanism, standardization may be required for RFSP index coding to allow other network elements to identify where Wi-Fi service subscription bit is located within the RFSP index or then the operator needs to coordinate RFSP index value use with vendors.

According to a variation of the procedure shown in FIG. 7, exemplary additional operations are given, which are inherently independent from each other as such.

According to such variation, an exemplary method according to exemplary embodiments of the present invention may comprise an operation of transmitting said index.

According to exemplary embodiments of the present invention, said capability is at least one of support for said radio access technology, availability of service subscription for said radio access technology, and support for a network side mechanism in relation to said radio access technology (e.g. interworking of a radio access network with said radio access technology).

According to exemplary embodiments of the present invention, the radio access technology is Wi-Fi, or 3GPP radio access technology (or any other conceivable radio access technology or frequency band). Namely, according to still another embodiment of the present invention, the radio access technology is 3GPP radio access technology, like LTE 3.5 small cell, as already mentioned above. For example, an operator may dedicate certain 3GPP frequency band for gold, premium or VIP users to ensure better service quality. In the similar way as for Wi-Fi, the user may need to have separate service subscription to such a frequency band/network layer. Thus the special 3GPP frequency band, like 3.5 GHz small cell band being currently defined for 3GPP networks, could serve as the radio access technology, although in the preceding description the Wi-Fi is used as an example. In general, the radio access technology is thus not to be understood to be limited to Wi-Fi or the 3GPP 3.5 GHz small cell band, but instead those technologies are to be considered merely as examples for various radio access technologies or frequency bands to be used for traffic besides the main mobile network.

It is further noted that according to exemplary embodiments of the present invention, in addition to the generic right (i.e. user based permission) to access e.g. 3.5 band (or other technologies/bands), zones might be defined. That is, e.g. 3.5 band support is indicated by the index only in selected areas defined by the operator (e.g. when the user is at home the operator has defined that the user is able to access certain RAT (like 3.5) available in home area (like providing indoor coverage in a skyscraper)), but otherwise the user is not allowed to access and benefit from the RAT (and get high speed connections via 3.5 small cell base station). In other words, according to exemplary embodiments of the present invention, the availability of service subscription may be a local permission.

According to still further embodiments of the present invention, the availability of service subscription may be a temporal permission, that is, for example a user/UE belongs to a group that is allowed to utilize small cells only during busy hour but otherwise shall use macro RATs.

Each of the above mentioned settings may be identified by a certain bit position within a certain bit range in the index.

The location and time based limitations may apply to both 3GPP and Wi-Fi RATs (and other exemplary technologies/bands).

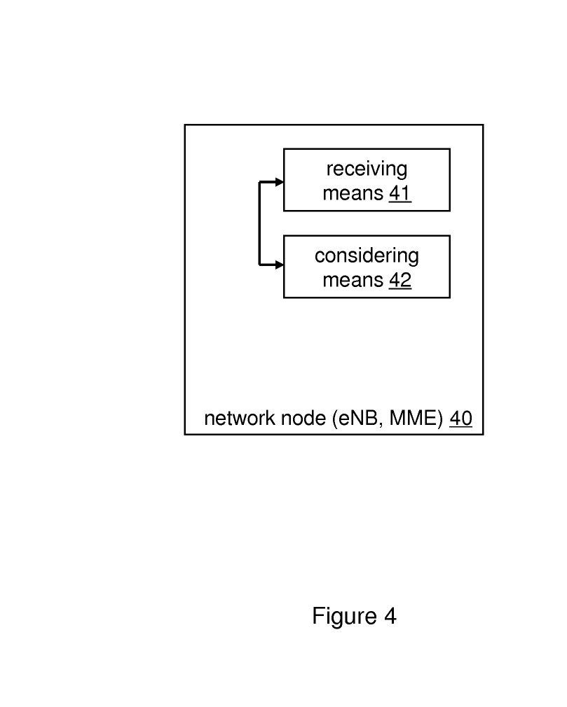

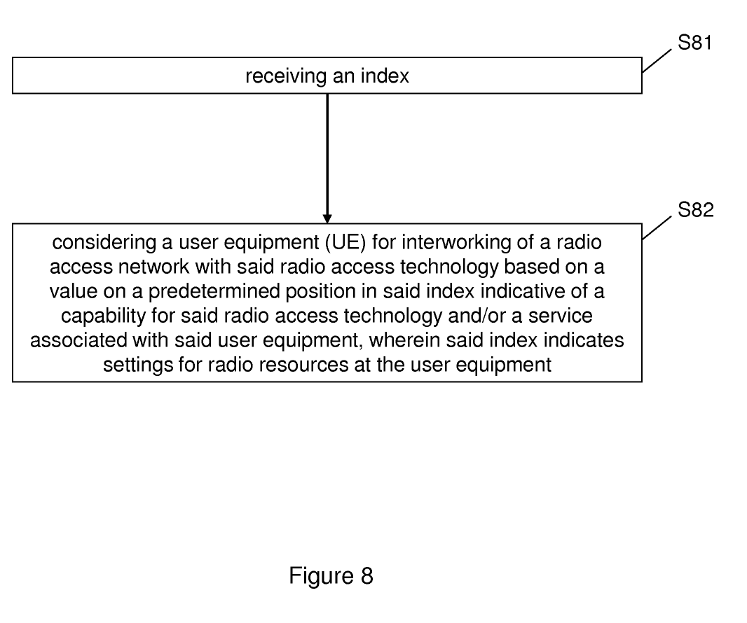

FIG. 4 is a block diagram illustrating an apparatus according to exemplary embodiments of the present invention. The apparatus may be a network node such as an eNB or a mobility management entity. FIG. 8 is a schematic diagram of a procedure according to exemplary embodiments of the present invention. The apparatus according to FIG. 4 may perform the method of FIG. 8 but is not limited to this method. The method of FIG. 8 may be performed by the apparatus of FIG. 4 but is not limited to being performed by this apparatus.

As shown in FIG. 4, according to exemplary embodiments of the present invention, the apparatus comprises a receiving means 41 and a considering means 42. As shown in FIG. 8, a procedure according to exemplary embodiments of the present invention comprises an operation of receiving an index, and an operation of considering a user equipment (UE) for interworking of a radio access network with said radio access technology based on a value on a predetermined position in said index indicative of a capability for said radio access technology and/or a service associated with said user equipment, wherein said index indicates settings and/or management strategies for radio resources at the user equipment.

According to exemplary embodiments of the present invention, the capability is at least one of support for said radio access technology, availability of service subscription for said radio access technology, and support for a network side mechanism in relation to said radio access technology (e.g. interworking of a radio access network with said radio access technology).

According to further exemplary embodiments of the present invention, the radio access technology is Wi-Fi, or 3GPP radio access technology (or any other conceivable radio access technology or frequency band).

According to still further embodiments of the present invention, the predetermined position is a bit position in said index, or the predetermined position is a bit range in said index as already described above.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity/element (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

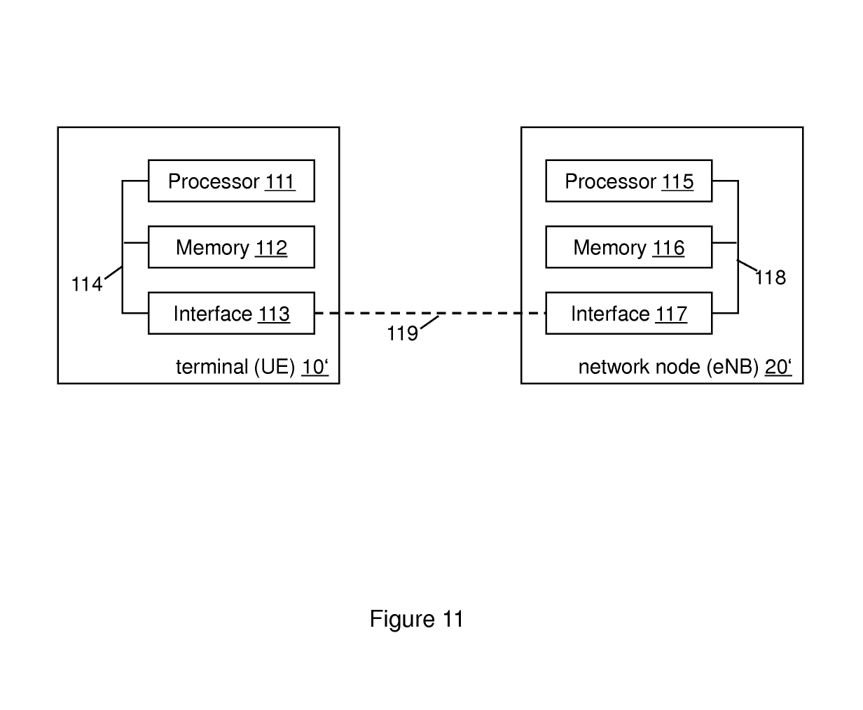

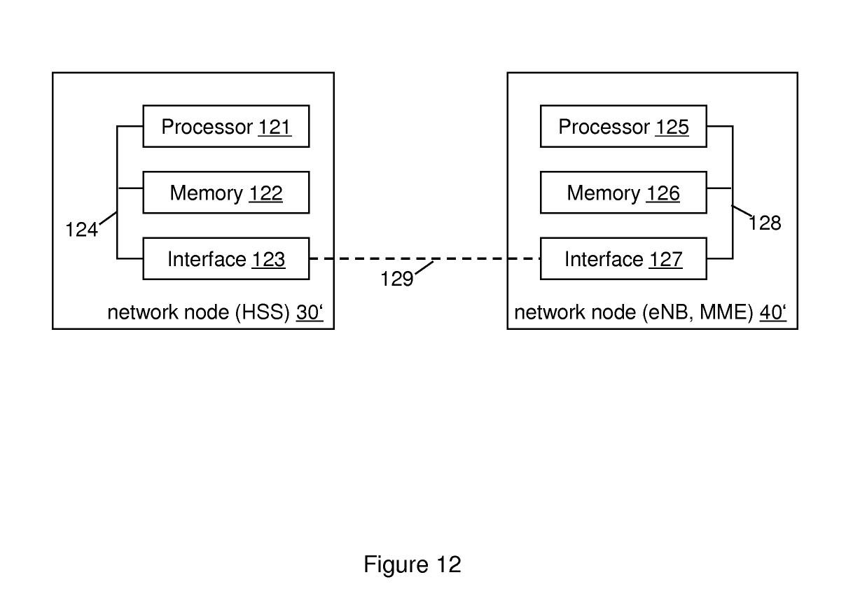

In FIGS. 11 and 12, an alternative illustration of apparatuses according to exemplary embodiments of the present invention is depicted. As indicated in FIG. 11, according to exemplary embodiments of the present invention, the apparatus (terminal) 10′ (corresponding to the terminal 10) comprises a processor 111, a memory 112 and an interface 113, which are connected by a bus 114 or the like. Further, according to exemplary embodiments of the present invention, the apparatus (network node) 20′ (corresponding to the network node 20) comprises a processor 115, a memory 116 and an interface 117, which are connected by a bus 118 or the like, and the apparatuses may be connected via link 119, respectively. As indicated in FIG. 12, according to exemplary embodiments of the present invention, the apparatus (network node) 30′ (corresponding to the network node 30) comprises a processor 121, a memory 122 and an interface 123, which are connected by a bus 124 or the like. Further, according to exemplary embodiments of the present invention, the apparatus (network node) 40′ (corresponding to the network node 40) comprises a processor 125, a memory 126 and an interface 127, which are connected by a bus 128 or the like, and the apparatuses may be connected via link 129, respectively.

The processor 111/115/121/125 and/or the interface 113/117/123/127 may also include a modem or the like to facilitate communication over a (hardwire or wireless) link, respectively. The interface 113/117/123/127 may include a suitable transceiver coupled to one or more antennas or communication means for (hardwire or wireless) communications with the linked or connected device(s), respectively. The interface 113/117/123/127 is generally configured to communicate with at least one other apparatus, i.e. the interface thereof.

The memory 112/116/122/126 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the terminal 10 comprises at least one processor 111, at least one memory 112 including computer program code, and at least one interface 113 configured for communication with at least another apparatus. The processor (i.e. the at least one processor 111, with the at least one memory 112 and the computer program code) is configured to perform dynamically determining capability for a radio access technology while being connected to a communication network (thus the apparatus comprising corresponding means for determining), and to perform transmitting, via said connection to said communication network, a message comprising an information element indicative of said capability for said radio access technology (thus the apparatus comprising corresponding means for transmitting).

According to exemplary embodiments of the present invention, an apparatus representing the network node 20 comprises at least one processor 115, at least one memory 116 including computer program code, and at least one interface 117 configured for communication with at least another apparatus. The processor (i.e. the at least one processor 115, with the at least one memory 116 and the computer program code) is configured to perform receiving a message comprising an information element indicative of capability for a radio access technology associated with a user equipment (UE) (thus the apparatus comprising corresponding means for receiving), and to perform considering a sender of said message for interworking of a radio access network with said radio access technology in terms of said user equipment based on said capability (thus the apparatus comprising corresponding means for considering).

According to exemplary embodiments of the present invention, an apparatus representing the network node 30 comprises at least one processor 121, at least one memory 122 including computer program code, and at least one interface 123 configured for communication with at least another apparatus. The processor (i.e. the at least one processor 121, with the at least one memory 122 and the computer program code) is configured to perform obtaining capability for a radio access technology and/or a service associated with a user equipment (UE) (thus the apparatus comprising corresponding means for obtaining), and to perform dynamically modifying a predetermined position in an index based on said capability, wherein said index indicates settings for radio resources at said user equipment (thus the apparatus comprising corresponding means for modifying).

According to exemplary embodiments of the present invention, an apparatus representing the network node 40 comprises at least one processor 125, at least one memory 126 including computer program code, and at least one interface 127 configured for communication with at least another apparatus. The processor (i.e. the at least one processor 125, with the at least one memory 126 and the computer program code) is configured to perform receiving an index (thus the apparatus comprising corresponding means for receiving), and to perform considering a user equipment (UE) for interworking of a radio access network with said radio access technology based on a value on a predetermined position in said index indicative of a capability for said radio access technology and/or a service associated with said user equipment, wherein said index indicates settings for radio resources at the user equipment (thus the apparatus comprising corresponding means for considering).

In case support for Wi-Fi access, Wi-Fi service or RAN/Wi-Fi Interworking feature changes in the UE, for example Wi-Fi module is added (e.g. USB, Wi-Fi device paired), user buys Wi-Fi service subscription or operator enables Wi-Fi service subscription, the UE may change dynamically “UE radio access capability” information element (or alike). In order to transfer the updated information element to the network, the UE can send the information element immediately or when following current 3GPP standards the UE may wait until the next time the UE is in IDLE mode (no active communication) and then perform re-attachment to the mobile network in order to send updated “UE radio access capability” information element to the network.

For further details regarding the operability/functionality of the individual apparatuses, reference is made to the above description in connection with any one of FIGS. 1 to 10, respectively.

Although dynamically determining and reporting UE Wi-Fi capability while the UE is being wirelessly connected to a 3GPP RAN is illustrated in FIGS. 1 to 10 to enable managing the usage of Wi-Fi radio technology via the 3GPP network, the invention is not so limited. In this regard, dynamically determining and reporting any other non-3GPP capability of the UE, for example, Bluetooth capability, CDMA capability and/or WiMAX capability, to the 3GPP network while the UE is being wirelessly connecting to the 3GPP RAN, so as to enable managing the usage of the corresponding non-3GPP radio technologies via the 3GPP network may also be supported without departing from the spirit and scope of the various embodiments of the invention.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for Wi-Fi support awareness. Such measures exemplarily comprise dynamically determining capability for a radio access technology while being connected to a communication network, and transmitting, via said connection to said communication network, a message comprising an information element indicative of said capability for said radio access technology.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

### 3G 3^{rd} Generation

### 3GPP 3^{rd} Generation Partnership Project

AAA authentication, authorization and accounting

### ANDSF Access Network Discovery and Selection Function

### ANQP Access Network Query Protocol

### DM Device Management

eNB evolved Node B

### FQDN Fully Qualified Domain Name

### Hetnet Heterogeneous Networks

HSS home subscriber server

### LTE Long Term Evolution

MME mobility management entity

### RAN Radio Access Network

RAT radio access technology
RFSP radio frequency selection priority
SIM subscriber identity module
SSID service set identifier
TS technical specification
UE user equipment
USIM universal subscriber identity module

1. A method comprising
dynamically determining capability for a radio access technology while being connected to a communication network, and
transmitting, via said connection to said communication network, a message comprising an information element indicative of said capability for said radio access technology only in case of being able to access networks using the radio access technology.

2. The method according to claim 1, wherein
said capability is at least one of
support for said radio access technology,
availability of service subscription for said radio access technology, and
support for a network side mechanism in relation to said radio access technology.

3. The method according to claim 1, comprising
listening for networks utilizing said radio access technology, and
checking whether known and accessible networks utilizing said radio access technology are listened, wherein
said capability comprises that known and accessible networks utilizing said radio access technology are listened.

4. The method according to claim 2, wherein
said network side mechanism in relation to said radio access technology is an interworking of a radio access network with said radio access technology.

5. The method according to claim 1, wherein
said radio access technology is Wi-Fi, or
said radio access technology is a 3GPP radio access technology, or
said radio access technology is a certain frequency band of a 3GPP radio access technology.

6. The method according to claim 2, wherein
in relation to said determining, the method further comprises at least one of
receiving, via said connection to said communication network, access network discovery and selection function information as information regarding service subscription for said radio access technology,
receiving, via said connection to said communication network, hotspot 2.0 information as information regarding service subscription for said radio access technology, and
obtaining settings related to said radio access technology as information regarding service subscription for said radio access technology.

7-9. (canceled)

10. A method comprising
receiving a message comprising an information element indicative of capability for a radio access technology associated with a user equipment (UE), wherein the message is transmitted only in case the UE is able to access networks using the radio access technology, and
considering a sender of said message for interworking of a radio access network with said radio access technology in terms of said user equipment based on said capability.

11. The method according to claim 10, wherein
said capability is at least one of
support for said radio access technology,
availability of service subscription for said radio access technology,
support for a network side mechanism in relation to said radio access technology, and
that known and accessible networks utilizing said radio access technology are listened.

12. The method according to claim 11, wherein
said network side mechanism in relation to said radio access technology is an interworking of a radio access network with said radio access technology.

13. The method according to claim 10, wherein
said radio access technology is Wi-Fi, or
said radio access technology is a 3GPP radio access technology, or
said radio access technology is a certain frequency band of a 3GPP radio access technology.

14. The method according to claim 10, further comprising at least one of
transmitting access network discovery and selection function information as information regarding service subscription for said radio access technology, and
transmitting hotspot 2.0 information as information regarding service subscription for said radio access technology.

15-29. (canceled)

30. An apparatus comprising;
at least one processor; and
at least one memory comprising computer program code,
the at least one memory and the computer program code, with the at least one processor, causing the apparatus at least to
dynamically determine capability for a radio access technology while being connected to a communication network, and
transmit, via said connection to said communication network, a message comprising an information element indicative of said capability for said radio access technology only in case of being able to access networks using the radio access technology.

31. The apparatus according to claim 30, wherein
said capability is at least one of
support for said radio access technology,
availability of service subscription for said radio access technology, and
support for a network side mechanism in relation to said radio access technology.

32. The apparatus according to claim 30, wherein the at least one memory and the computer program code are further configured, with the at least one processor, to cause the apparatus at least to:
listen for networks utilizing said radio access technology, and
check whether known and accessible networks utilizing said radio access technology are listened, wherein
said capability comprises that known and accessible networks utilizing said radio access technology are listened.

33. (canceled)

34. The apparatus according to claim 30, wherein
said radio access technology is Wi-Fi, or
said radio access technology is a 3GPP radio access technology, or
said radio access technology is a certain frequency band of a 3GPP radio access technology.

35. The apparatus according to claim 31, wherein the at least one memory and the computer program code are further configured, with the at least one processor, to cause the apparatus at least to:
receive, via said connection to said communication network, access network discovery and selection function information as information regarding service subscription for said radio access technology,
receive, via said connection to said communication network, hotspot 2.0 information as information regarding service subscription for said radio access technology, and
obtain settings related to said radio access technology as information regarding service subscription for said radio access technology.

36-38. (canceled)

39. An apparatus comprising:
at least one processor; and
at least one memory comprising computer program code,
the at least one memory and the computer program code, with the at least one processor, causing the apparatus at least to
receive a message comprising an information element indicative of capability for a radio access technology associated with a user equipment (UE), and
consider a sender of said message for interworking of a radio access network with said radio access technology in terms of said user equipment based on said capability.

40. The apparatus according to claim 39, wherein
said capability is at least one of
support for said radio access technology,
availability of service subscription for said radio access technology,
support for a network side mechanism in relation to said radio access technology, and
that known and accessible networks utilizing said radio access technology are listened.

41. (canceled)

42. The apparatus according to claim 39, wherein
said radio access technology is Wi-Fi, or
said radio access technology is a 3GPP radio access technology, or
said radio access technology is a certain frequency band of a 3GPP radio access technology.

43. The apparatus according to claim 39, wherein the at least one memory and the computer program code are further configured, with the at least one processor, to cause the apparatus at least to:
transmit access network discovery and selection function information as information regarding service subscription for said radio access technology, and
transmit hotspot 2.0 information as information regarding service subscription for said radio access technology.

44-60. (canceled)
